(19) United States
(12) Patent Application Publication
(10) Pub. No.: US 2014/0325329 A1
(43) Pub. Date: Oct. 30, 2014

(54) Visual Analytics of Multivariate Data Using a Cell Based Calendar Matrix having a Visual Folding Mechanism

(71) Applicant: HEWLETT-PACKARD DEVELOPMENT COMPANY, L.P., (US)

(72) Inventors: Ming C. Hao, Palo Alto, CA (US); Halldor Janetzko, Hauptstrass (DE); Manish Marwah, Palo Alto, CA (US); Umeshwar Dayal, Saratoga, CA (US); Meichun Hsu, Los Altos Hills, CA (US); Daniel Keim, Konstanz (DE)

(73) Assignee: HEWLETT-PACKARD DEVELOPMENT COMPANY, L.P., Houston, TX (US)

(21) Appl. No.: 13/869,675

(22) Filed: Apr. 24, 2013

(51) Int. Cl. G06F 17/24

(52) U.S. Cl. CPC G06F 17/246
USPC 715/215

(57) ABSTRACT

Visual analytics of multivariate data using a cell based calendar matrix having a visual folding mechanism can include forming a time based layout that is divided into cells where the cells represent measurement intervals and a color of the cells represents a measurement value, folding the time based layout into a cell based calendar matrix with other time based layouts that include other cells that represent corresponding measurement intervals in different calendar units of the cell based calendar matrix, and displaying the cell based calendar matrix in a display such that the cells of the time based layout align by time with the other cells of the other time based layouts.

### BACKGROUND

Line charts can be used for visualizing time series data. Such line charts are intuitive and easy-to-use. For example, measurements from sensors that monitor the operating parameters of a machine may be collected and inserted into short line chart to assist users in understanding the measurements.

### BRIEF DESCRIPTION OF THE DRAWINGS

The application file contains at least one drawing executed in color. Copies of this patent application publication with color drawing(s) will be provided by the Office upon request and payment of the necessary fee.

The accompanying drawings illustrate various examples of the principles described herein and are a part of the specification. The illustrated examples are merely examples and do not limit the scope of the claims.

FIG. 1 is a diagram of an example of sensors in communication with a display system according to the principles described herein.

FIG. 2 is a diagram of an example of an hour layout according to the principles described herein.

FIG. 3 is a diagram of an example of displaying an hour layout with colors representing measurement values according to the principles described herein.

FIG. 4 is a diagram of an example of a day layout according to the principles described herein.

FIG. 5 is a diagram of an example of displaying a day layout with colors representing measurements values according to the principles described herein.

FIG. 6 is a diagram of an example of an interactive data set time line according to the principles described herein.

FIG. 7 is a diagram of an example of a week layout according to the principles described herein.

FIG. 8 is a diagram of an example of displaying a week layout with colors representing measurement values according to the principles described herein.

FIG. 9 is a diagram of an example of an interactive data set time line according to the principles described herein.

FIG. 10 is a diagram of an example of a month layout according to the principles described herein.

FIG. 11 is a diagram of an example of displaying a month layout with colors representing measurement values according to the principles described herein.

FIG. 12 is a diagram of an example of an interactive data set time line according to the principles described herein.

FIG. 13 is a diagram of an example of a year layout according to the principles described herein.

FIG. 14 is a diagram of an example of displaying a year layout with colors representing measurement values according to the principles described herein.

FIG. 15 is a diagram of an example of a method of visual analytics of multivariate data using a calendar matrix according to the principles described herein.

FIG. 16 is a diagram of an example of a display system according to the principles described herein.

FIG. 17 is a diagram of an example of a display system according to the principles described herein.

### DETAILED DESCRIPTION

While time series line charts are intuitive and easy to use, long-running series of data provide so much information to line charts that the line charts become less useful due to over plotting. For example, finding patterns and anomalous behaviors in long-running time series of data with tens of thousands of measurement points is difficult because the amount of data is overwhelming.

The principles described herein include a method of visual analytics of multivariate data using a cell based calendar matrix with a visual folding mechanism. Such a method can include forming a time based layout that is divided into cells where the cells represent measurement intervals and a color of the cells represents a measurement value, folding the time based layout into a cell based calendar matrix with other time based layouts that include other cells that represent corresponding measurement intervals in different calendar units of the cell based calendar matrix, and displaying the cell based calendar matrix in a display such that the cells of the time based layout align by time with the other cells of the other time based layouts. Such principles allow a user to see large amounts of multivariate time series data in a single display in an intuitive manner. The visual folding mechanism causes the layouts to be included in larger calendar units or smaller calendar units in the display. Such a visual folding mechanism may be activated based on user input. The user input may define the time period of the calendar unit into which the layout is folded.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

FIG. 1 is a diagram of an example of sensors in communication with a display system (100) according to the principles described herein. In this example, multiple sensors (102, 104, 106, 108, 110) are in communication with multiple data center components (112, 114, 116, 118, 120) over time. The sensors (102, 104, 106, 108, 110) may measure at least one metric that pertains to the data center components (112, 114, 116, 118, 120). For example, the metrics may include values pertaining to temperature, bandwidth, error rate, failure rate, congestion, energy consumption, other metrics, or combinations thereof. The sensors (102, 104, 106, 108, 110) may send their recorded measurements to the display system (100). The display system (100) has a display (122), a time line generator (124), and an ability to present the metrics measured with the sensors (102, 104, 106, 108, 110) in the display (122) using a calendar matrix along a data set time line generated with the time line generator (124). The cells of the calendar matrix are synchronized to the data set time line. Each of the cells represents a measurement interval, and the color of the cells represents a measurement value. Each of the cells can be displayed in the display. In some examples, the cells can be as small as a single pixel. In other examples, multiple cells form a single cell. The cell size may be dependent on the type of calendar units displayed in the calendar matrix.

The display may be a digital monitor, a high resolution display, or another type of display that is capable of presenting a calendar matrix and an interactive data set time line simultaneously. The calendar matrix may be presented in an hour view, a day view, a week view, a month view, a year view, another time period view, or combinations thereof. A user may have an option to switch between the views to analyze data that the user determines interesting. The hour view may include an hour layout that is divided in cells. Each cell represents a measurement interval, and a color of the cell represents a measurement value taken during that measurement interval. Any appropriate number of cells may be used to equal an hour. The cells may be arranged in a single row, a single column, or a combination of rows and columns. In some examples, the hour layout is divided into twelve cells that represent five minute intervals. The twelve cells are arranged in three columns and four rows.

The cells of the time based layout are displayed with an interactive data series time line. The cells are synchronized with the interactive data series time line such that the cells can be selected with the interactive data series time line. In some examples, the interactive data series time line can also be used to switch to different calendar views.

The time based layout may be folded into a larger calendar unit of the calendar matrix. For example, an hour time based layout may be folded into a two hour layout, a multiple hour layout, a day layout, a week layout, a month layout, a year layout, another time period layout, or combinations thereof. In some examples, the user has an option to define the time period into which the time based layout is folded. Further, the user may also cause the layout to be folded into smaller time based units. For example, a day layout may be folded into a half day layout, an hour layout, a half hour layout, another time period layout, or combinations thereof. Thus, the user may take a layout and fold it up into a larger calendar unit or down into a smaller calendar unit based on user input.

As desired by the user, the hour unit may be folded into a day layout and displayed as the day view. The day layout may include twenty four hour layouts to equal a day. The hour layouts may be arranged in the day layout in a single row, a single column, or a combination of rows and columns. In some examples, the twenty four hour layouts are arranged in the day layout in six columns and four rows.

The user may also cause the day layout to be folded into a week layout and to be displayed in a week view. The week layout may include seven day layouts combined to form a week. The day layouts may be arranged in the week layout in a single row, a single column, or a combination of rows and columns. In some examples, the seven day layouts are arranged in the week layout in four columns and two rows.

In other examples, the user causes the week layout to be folded into a month layout and to be displayed in a month view. The month layout may include four or five week layouts combined to form a month. The week layouts may be arranged in the month layout in a single row, a single column, or a combination of rows and columns. In some examples, the day layout may fold directly into a month layout.

Further, the user may cause the month layout to be folded into a year layout and to be displayed in a year view. The year layout may include twelve month layouts combined to form a year. The month layouts may be arranged in the year layout in a single row, a single column, or a combination of rows and columns. In some examples, the twelve month layouts are arranged in the year layout in four columns and three rows.

Each of the calendar views may mimic the organization that is common to the user's experience. For example, annual calendars for a particular culture of the world may be organized in a single view such that the months are arranged in four columns and three rows. In such an example, the year view of the calendar matrix may mimic that organization so that the arrangement of month layouts in the year view is intuitive to the user. Further, the user may have the option of defining the organization and/or arrangement in the calendar views to meet the user's preferences.

The intuitive arrangement of the calendar units in the calendar view causes the cells to be aligned by time and further allows a user to recognize patterns over time. For example, the user may notice in a month view that on every day of the week that a particular behavior is exhibited. As a result, the user may switch to a year view to see quickly if the same behavior is exhibited in the other months because the user intuitively knows where to find the days in question in the year view based on the cells alignment by time.

Each of the calendar views may be displayed with an interactive data set time line. The interactive data set time line may include a segment of time that spans the duration or at least a portion of the duration of when the measurements were taken. For example, if measurements in the data center were taken for a full year from January 1^{st} to December 31^{st}, the interactive data set time line may span an entire year. A highlighted portion of the interactive data set time line can represent the calendar view shown in the display. For example, if the measurements for the month of February are shown in a month view, a portion of the interactive data set time line that represents February is highlighted.

If the user wants to view other months of the calendar matrix in the display, the user may interact with the interactive data set time line to switch between the months or other calendar units that are being shown in the display. Further, the user may be able to switch between different types of calendar views based on his interaction with the interactive data set time line. For example, the user may click on the time period on the interactive data set time line that represents the calendar view that the user desires to see.

In other examples, the user may select which of the views and/or calendar units that the user desires to see through the user's interaction with the calendar matrix. For example, the user may click on the month layout, the week layout, the day layout, the hour layout, or another time based layout that the user wants to visually analyze in greater detail. In response to clicking on these layouts when the calendar view includes more than just the selected layout, the calendar view may change to view just that selected layout. As a result, the user may continue to drill down to smaller increments in time to focus the user's analysis on smaller time periods. In other examples, the user may hover a cursor icon over a layout, a boundary of a layout, or another portion of a layout to cause additional information about the measurements taken during the selected layout's corresponding time period. Such information may be a repeat of the information already available in the display, more detailed information than is already in the display, different information than what is represented by the color in the cells, or combinations thereof.

While this example has been described with reference to specific types of interaction that a user may have to switch views, switch between calendar units, or cause additional information to appear in the display, any type of interaction to cause these actions or related actions to occur may be used in accordance with the principles described herein. For example, the user may use a cursor input, a keyboard input, a voice input, a touch screen input, a hand motion gesture input, another type of input, or combinations thereof.

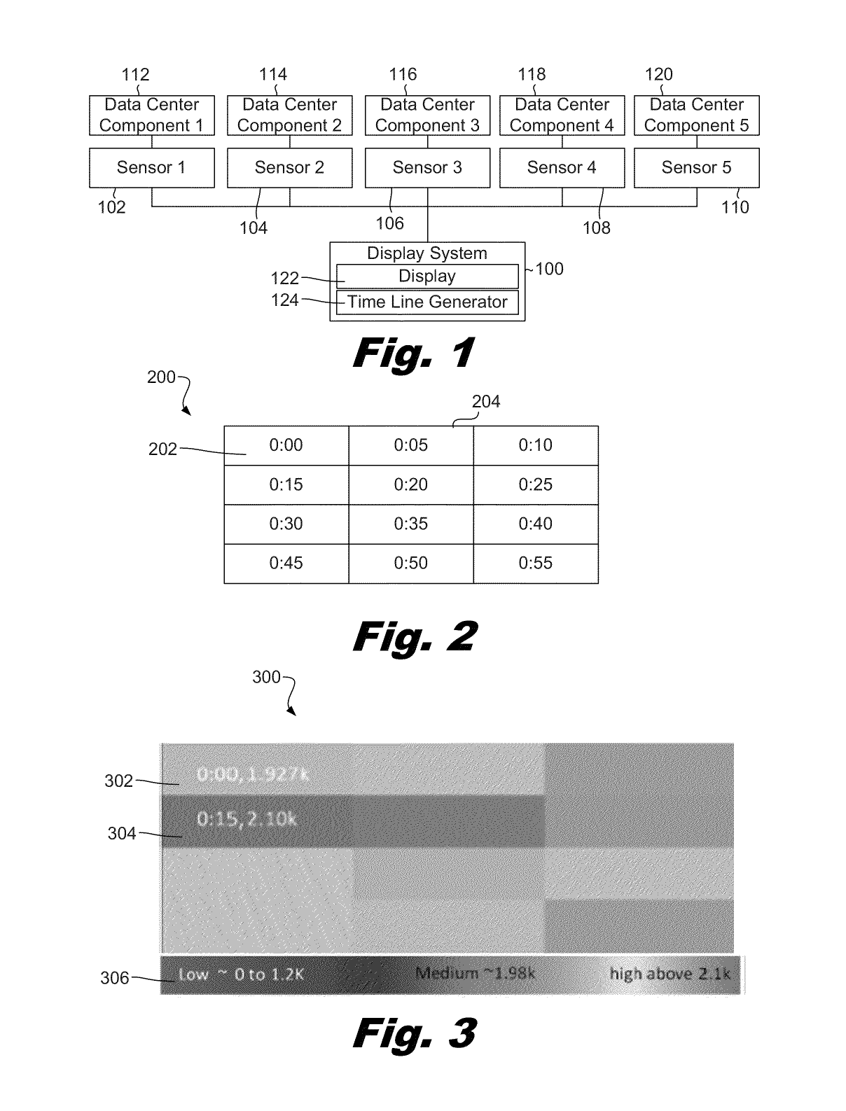

FIG. 2 is a diagram of an example of an hour layout (200) according to the principles described herein. In this example, the hour layout (200) has twelve cells that represent measurement intervals taken with sensors. The first cell (202) represents a measurement taken at 0:00 of an hour. The second cell (204) represents a measurement taken five minutes into the hour at 0:05. The values of each of the measurements are determined, which are used to determine the color to display in each of the cells.

While this example has been described with reference to a particular layout arrangement, any appropriate layout arrangement may be used. Further, while this example has been described with reference to specific measurement intervals, any appropriate measurement intervals may be used in accordance with the principles described herein.

FIG. 3 is a diagram of an example of displaying an hour layout (300) with colors representing measurement values according to the principles described herein. In this example, colors represent a value of an energy consumption measurement of at least one component of a data center. The first cell (302) represents a measurement taken at 0:00 and displays an orange color. The fourth cell (304) was taken at 0:15 and displays a red color.

The colors of the cells represent the value of the metric measured at the respective time intervals. A color map (306) is displayed under of the hour layout (300) and associates the value of the measurements to the displayed colors. In this example, a red color represents a high energy consumption measurement value while a purple color represents a low energy consumption measurement value. The colors between the red and purple colors represent a progressive change in the measurement's values. For example, the color map represents a continuum that goes from purple to blue to green to yellow to orange to red to represent a progressive change from low to high power consumption. While this example has been described with reference to a specific color map, any appropriate color map may be used in accordance with the principles described herein. For example, different colors may be used in the color map, or the colors may be used in a different order. Further, other color maps may include just two colors and a transition between the colors. In yet other examples, the color map uses a single color and alters the brightness of that color to represent a change in the measurement's value.

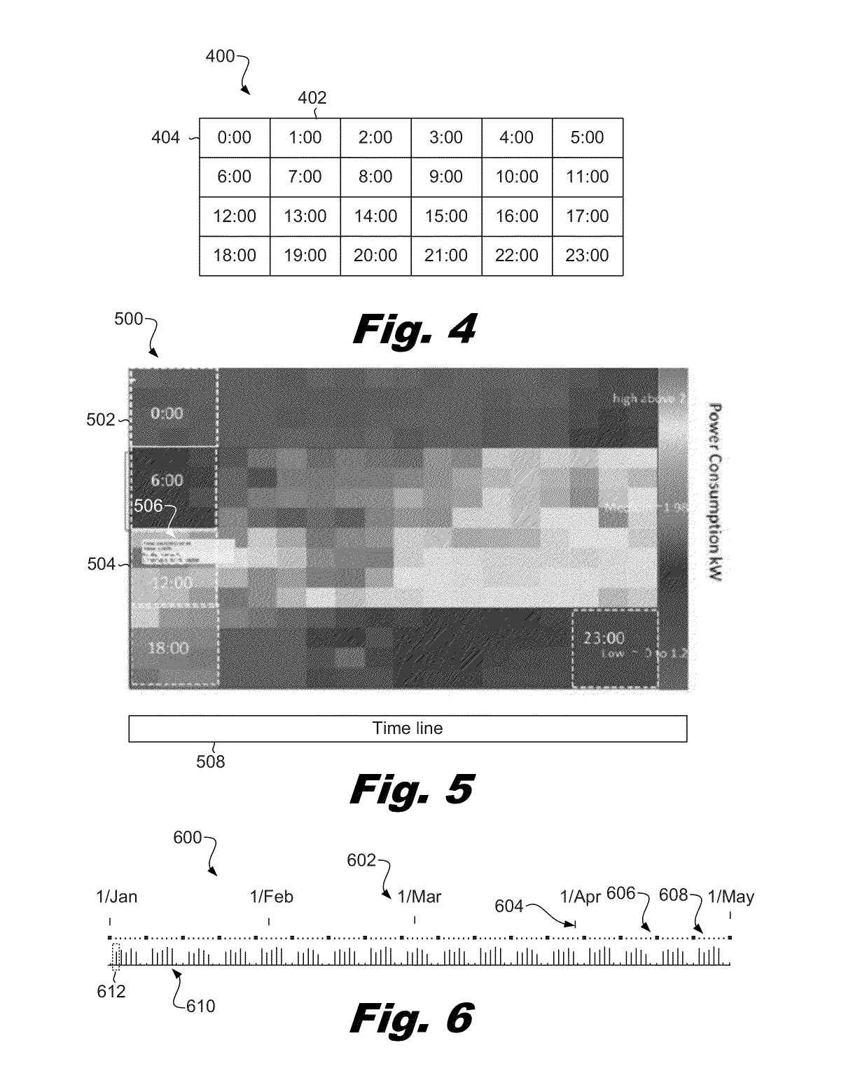

FIG. 4 is a diagram of an example of a day layout (400) according to the principles described herein. In this example, the hour layouts (300, FIG. 3) are folded into the day layout (400). Here, the day layout (400) has twenty four hour layouts. The first hour layout (402) represents the measurements during the first hour of the day, the second hour layout (404) represents the measurements taken during the second hour of the day, and so forth. While this example has been described with reference to a particular layout arrangement, any appropriate layout arrangement may be used.

FIG. 5 is a diagram of an example of displaying a day layout (500) with colors representing measurement values according to the principles described herein. In this example, the first hour layout (502) depicts the measurements that were taken during the first hour of the day. Purple is displayed in the first hour layout (502) representing that during the first hour of the day, little energy consumption was measured with the sensors. Each cell of the first hour layout (502) is a different shade of color representing different power consumption measurements at each time interval.

In the example of FIG. 5, each of the cell colors in the first hour layout (502) is a shade of purple indicating low power consumption measurements. The thirteenth hour layout (504) provides a greater visual contrast among its cells because shades of both orange and yellow colors are displayed in its cells. As a result, visual identification of each of the cells in the thirteenth hour layout (504) is visually easier to determine.

In this example, an information box (506) appears over the thirteenth hour layout (504). The information box (506) may appear in response to a user selecting the thirteenth hour layout (504) as a whole or selecting at least one of the cells in the thirteenth hour layout (504). The data in the information box (506) may include information pertaining to the selected cells in the selected hour layout or the information may pertain to just at least one of the cells. The information box (506) may be a pop-up window or another display mechanism.

The day layout (500) visually reveals that the energy consumption measurements are low during the night hours of the day and progressively get higher into the early afternoon hours. Such a pattern is visually apparent to a user. Each of the hour layouts is aligned in the same manner, such that the first top left cell of each of the hour layouts represents the first recorded measurements of the corresponding hour. Likewise, the positions of the other cells are also aligned by time. Thus, the user can intuitively understand what each cell represents in terms of time and measurement values.

An interactive data set time line (508) is also depicted in the example of FIG. 5. The interactive data set time line (508) is positioned below the day layout. However, the interactive data set time line may be displayed with the calendar matrix in any appropriate location in the display. For example, the interactive data set time line (508) may be displayed above the calendar matrix or to the side of the calendar matrix. More details about the interactive data set time line (508) will be given below.

FIG. 6 is a diagram of an example of an interactive data set time line (600) according to the principles described herein. In this example, the interactive data set time line (600) spans from January 1^{st} to May 1^{st}. Each month is identified with a label (602) and a mark (604). Each day of the month is identified with a dot where the first dot (606) of the week is larger than the other dots (608) that represent other days of the week. A bar (610) is located behind each of the dots. The heights of the bars correspond to the measurement value. Thus, the user can intuitively see the measurements' values in both the calendar matrix and the interactive data set time line.

The interactive data set time line (600) is linked to the calendar matrix that is depicted in the display. In some examples, when the view of the calendar matrix is a month view, the interactive data set time line (600) highlights the corresponding month that is displayed in the display. In this example, the interactive data set time line (600) has a highlighted section (612) that corresponds to the day layout (500, FIG. 5) in the example of FIG. 5. In other examples, just selected portions of the calendar matrix that are visible in the display are highlighted in the interactive data set time line (600). The user may select a view or a particular layout using the interactive data set time line (600). For example, the user may use a time line slider or other mechanism to select a view. In some examples, the user may cause the display to switch from showing the current layout in the display to another layout that is shown in the interactive data set time line, but not in the currently depicted calendar matrix. For example, if the calendar view includes a month view of the calendar layout for February, the user may cause the calendar view to switch to displaying the calendar layout for March.

While this example has been described with reference to a specific arrangement of items in a data set time line, any appropriate arrangement of items in a data set time line may be used in accordance with the principles described herein. For example, different indicators for the days, the month, or the value of the measurements may be used in the data set time line.

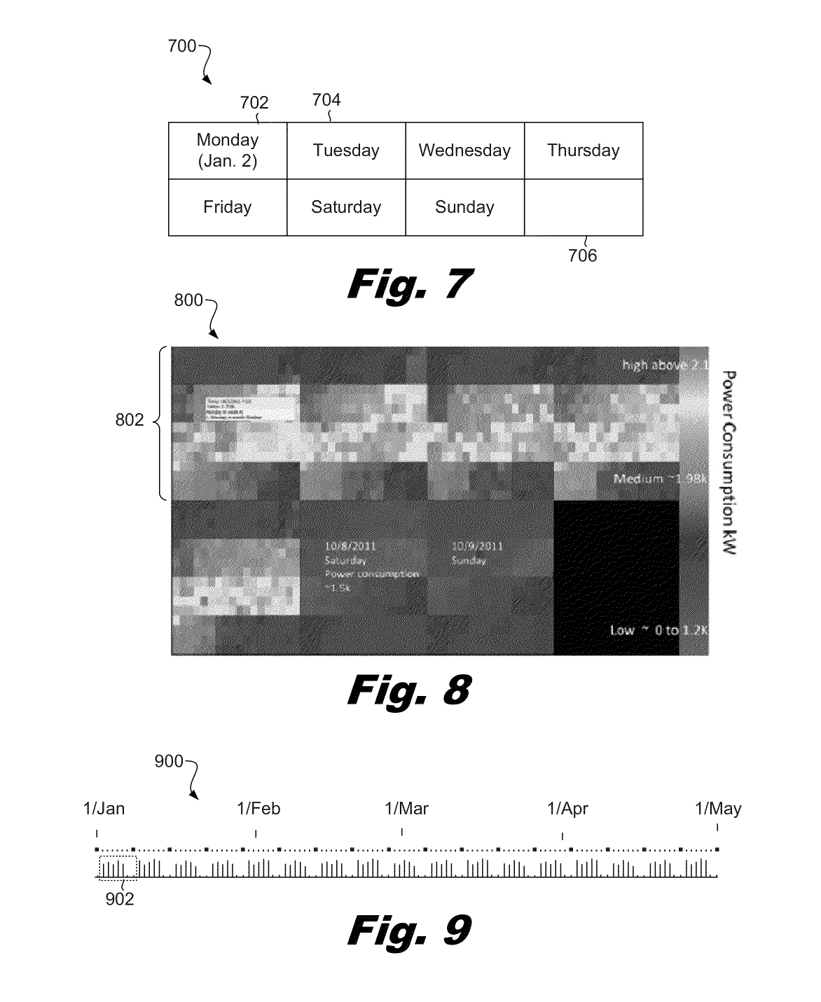

FIG. 7 is a diagram of an example of a week layout (700) according to the principles described herein. In this example, the day layouts (500, FIG. 5) are folded into the week layout (700). Here, the week layout (700) has seven day layouts. The first day layout (702) represents the measurements during the first day of the week, the second hour day layout (704) represents the measurements taken during the second day of the week, and so forth. While this example has been described with reference to a particular layout arrangement, any appropriate layout arrangement may be used.

In this example, the week layout (700) has two rows and four columns. In the depicted example, the last day (706) layout is blank because there are just seven days in a week. In other examples, the week layout (700) may have a single row of the seven day layouts.

FIG. 8 is a diagram of an example of displaying a week layout (800) with colors representing measurement values according to the principles described herein. In this example, the first day layout (802) depicts the measurements that were taken during the first day of the week. Each cell of the hour layout is still visible in the week layout (800). Thus, the user can still determine the measurement values for each of the measurement intervals taken every five minutes in a week view. Also, each of the day layouts is also visually identifiable.

In the example of FIG. 8, the week view reveals a daily pattern of power consumption. For example, on each week day of the week, the energy consumption measurements are low during the night time hours. While the day layout (500, FIG. 5) in FIG. 5 is consistent with this pattern, the pattern was not revealed until more day layouts were combined into the week view and the power consumption behaviors are depicted across a greater segment of time.

FIG. 9 is a diagram of an example of an interactive data set time line (900) according to the principles described herein. In this example, the interactive data set time line (900) corresponds to the week layout (800, FIG. 8) of FIG. 8. Thus, the highlighted section (902) of the interactive data set time line (900) includes the entire week depicted in FIG. 8.

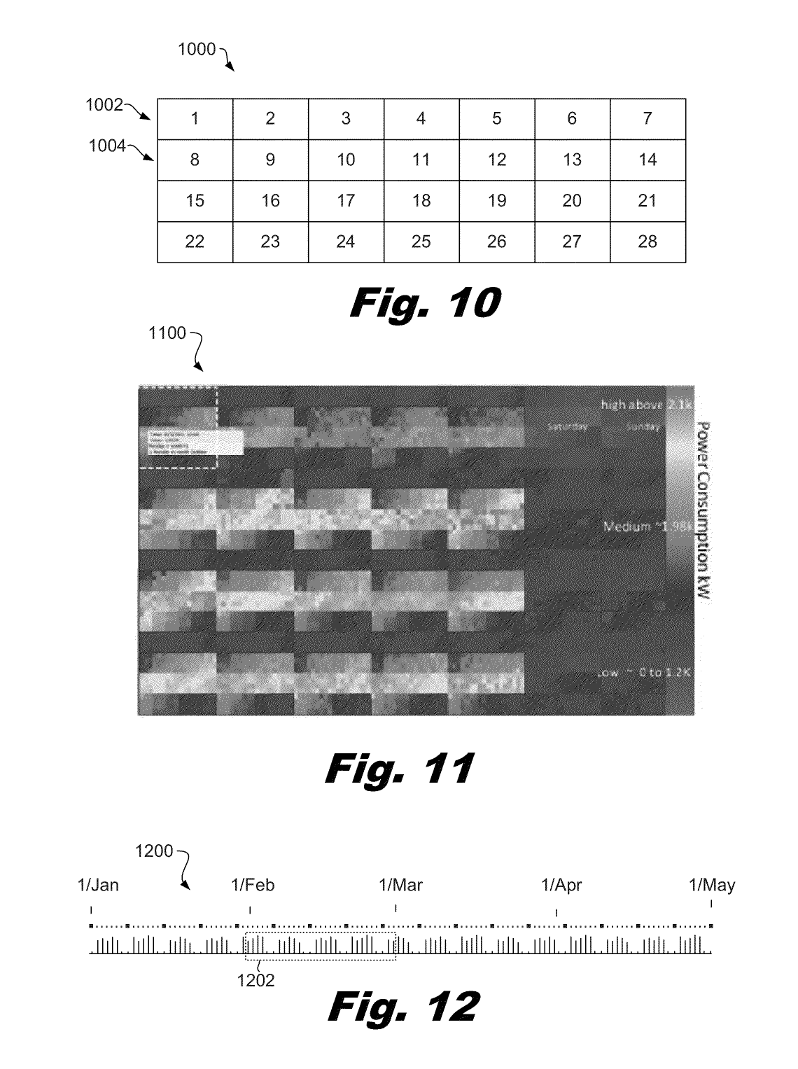

FIG. 10 is a diagram of an example of a month layout (1000) according to the principles described herein. In this example, the week layouts (800, FIG. 8) are folded into the month layout (1000). Here, the month layout (1000) has four week layouts. The first week layout (1002) represents the measurements during the first week of the month, the second week layout (1004) represents the measurements taken during the second week of the month, and so forth. While this example has been described with reference to a particular layout arrangement, any appropriate layout arrangement may be used. In this example, the week layouts are arranged such that the day layouts are arranged in a single row.

FIG. 11 is a diagram of an example of displaying a month layout (1100) with colors representing measurement values according to the principles described herein. The month view of the month layout (1100) confirms the pattern discovered in the week layout (800, FIG. 8) of low energy consumption measurements taken during the night hours. Further, an additional pattern is revealed in the month layout (1100) which depicts that the energy consumption during the weekends is also low.

The cells of the hour layout (200, FIG. 2) are still visible in the month layout (1100). Further, the hour layouts (200, FIG. 2), the day layouts (500, FIG. 5), and the week layouts (800, FIG. 8) are also visible. Thus, the user can visually understand the patterns and the power consumption levels at different times during the month. The daily and weekly patterns revealed by the month view establish a visual baseline that the user can compare to individual measurements. For example, if a cell in a day layout that represents a weekend day is red, the user can visible discern that the power consumption at such a time represented by that cell represents an anomalous behavior because the visual baseline depicts the other cells during such time as purple. As a result, the user can drill down using selection mechanisms to get more information about that cell or group of cells that exhibit the anomalous behavior.

FIG. 12 is a diagram of an example of an interactive data set time line (1200) according to the principles described herein. In this example, the interactive data set time line (1200) corresponds to the month layout (1100, FIG. 11) of FIG. 11. Thus, the highlighted section (1202) of the interactive data set time line (1100) includes the entire week depicted in FIG. 10.

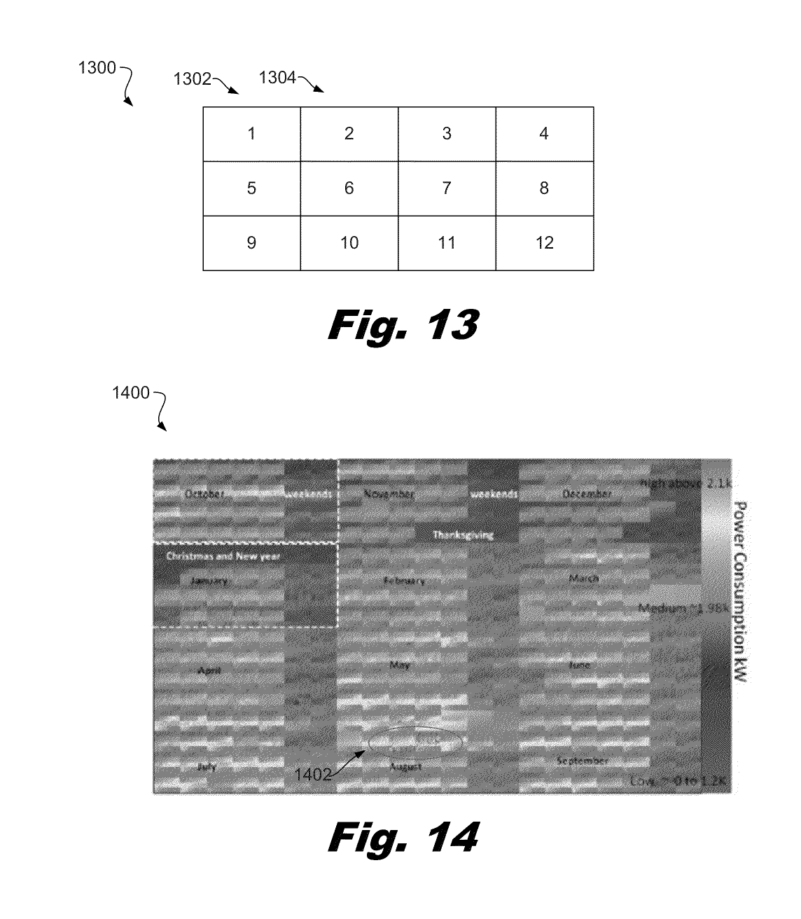

FIG. 13 is a diagram of an example of a year layout (1300) according to the principles described herein. In this example, the month layouts (1000, FIG. 10) are folded into the year layout (1300). Here, the year layout (1300) has twelve month layouts. The first month layout (1302) represents the measurements during the first month of the year, the second month layout (1304) represents the measurements taken during the second month of the year, and so forth. While this example has been described with reference to a particular layout arrangement, any appropriate layout arrangement may be used.

FIG. 14 is a diagram of an example of displaying a year layout (1400) with colors representing measurement values according to the principles described herein. The year view of the year layout (1400) confirms the patterns discovered in the week layout (800, FIG. 8) and the month layout (1100, FIG. 11) because more data supports that the energy consumption is low during the night hours and the weekends. The display may be a high resolution display such that all of the layouts and cells are visually detectable with the natural eye. In this example, a large amount of data is presented to the user in an intuitive manner in a single display where the user can intuitively detect areas of interest quickly even though the data includes very detailed data spanning for a year. Such areas of interest may be anomalies that represent higher or lower energy consumption than expected based on the energy consumption patterns exhibited throughout the calendar matrix. For example, the user can find the anomaly (1402) in August with the high energy consumption.

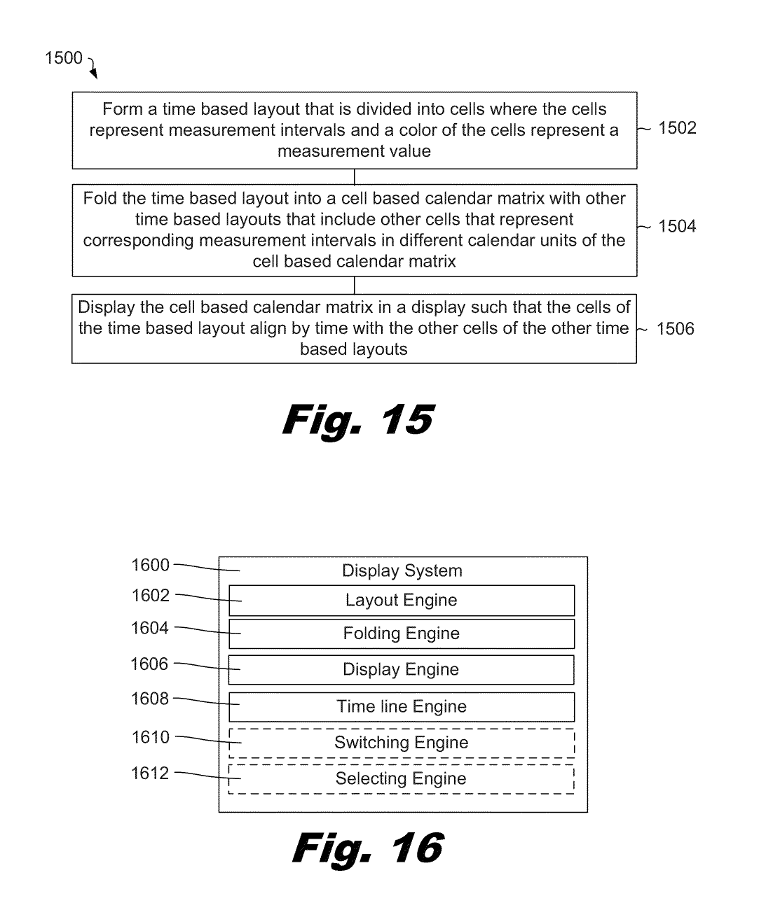

FIG. 15 is a diagram of an example of a method (1500) of visual analytics of multivariate data using a cell based calendar matrix according to the principles described herein. In this example, the method (1500) includes forming (1502) a time based layout that is divided into cells where the cells represent measurement intervals and a color of the cells represents a measurement value, folding (1504) the time based layout into a cell based calendar matrix with other time based layouts that include other cells that represent corresponding measurement intervals in different calendar units of the cell based calendar matrix, and displaying (1506) the cell based calendar matrix in a display such that the cells of the time based layout align by time with the other cells of the other time based layouts.

The cell based calendar matrix is a matrix that includes different calendar units that form calendar layouts. Each cell represents a value of a measurement interval. The calendar layouts have smaller layouts or cells that depict colors that represent the values of measurements taken at the corresponding times of the layouts and cells. The calendar view is what is displayed at a given moment in the display. Thus, a calendar unit may be displayed in the display. In such an example, where just the calendar unit is displayed in the display, the calendar unit equals the calendar view. For example, if just the month calendar unit is displayed in the display, then the calendar view is a month calendar view. The different calendar views, units, and layouts may be based on seconds, minutes, hours, days, weeks, months, years, decades, other time periods, or combinations thereof.

The user can switch between different calendars views by moving the data set time line. For example, the user may switch from a month view to a day view. In other examples, the user can switch to a different calendar unit. For example, the user can switch from a February calendar unit to a March calendar unit.

In some examples, the smallest time based layout is an hour layout with cells that represent smaller units of time, such as cells that represents minutes and/or seconds. The cells' colors represent the value of the measurement taken at the measurement intervals. The cells may represent five minute intervals and the cells may be arranged sequentially in three columns and four rows.

An interactive data set time line may also be displayed with the calendar matrix. The interactive data set time line is linked to the calendar matrix such that a highlighted section of the interactive data set time line corresponds with either a calendar view of the calendar matrix or a selected calendar unit of the calendar matrix within the calendar view. In some examples, the user can select calendar units of the calendar matrix using the interactive data set time line or otherwise control the calendar view with the interactive data set time line.

FIG. 16 is a diagram of an example of a display system (1600) according to the principles described herein. The display system (1600) has a layout engine (1602), a folding engine (1604), a display engine (1606), and a time line engine (1608). In this example, the display system (1600) also includes a switching engine (1610) and a selecting engine (1612). The engines (1602, 1604, 1605, 1606, 1608, 1610, 1612) refer to a combination of hardware and program instructions to perform a designated function. Each of the engines (1602, 1604, 1605, 1606, 1608, 1610, 1612) may include a processor and memory. The program instructions are stored in the memory and cause the processor to execute the designated function of the engine.

The layout engine (1602) creates time based layouts, such as the hour layouts, the day layouts, the week layouts, the month layouts, the year layouts, the other time based layouts, or combinations thereof. The folding engine (1604) folds the layouts up or down in the calendar matrix. For example, the day layouts can be folded into the week or month layouts, and so forth. The display engine (1606) displays the calendar views of the calendar matrix in a display. The time line engine (1608) generates the interactive data set time line that is displayed with the calendar views. The switching engine (1610) causes the display to switch between different calendar views, and the selecting engine causes calendar units to be selected based on user input.

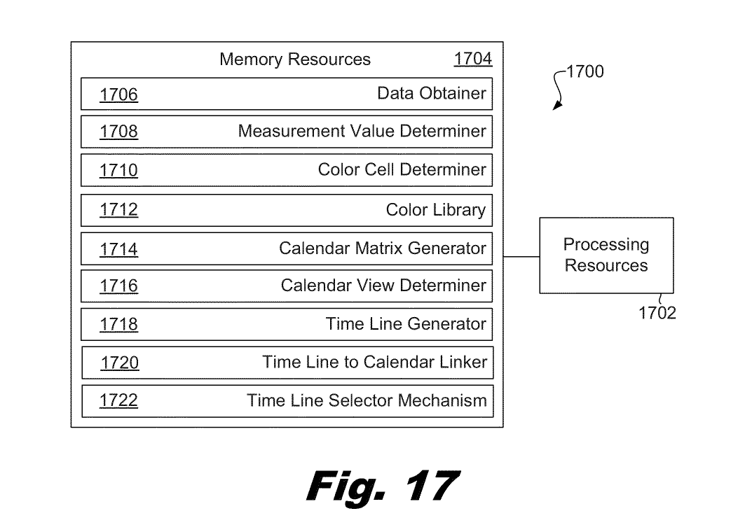

FIG. 17 is a diagram of an example of a display system (1700) according to the principles described herein. In this example, the display system (1700) includes processing resources (1702) that are in communication with memory resources (1704). Processing resources (1702) include at least one processor and other resources used to process programmed instructions. The memory resources (1704) represent generally any memory capable of storing data such as programmed instructions or data structures used by the display system (1700). The programmed instructions shown stored in the memory resources (1704) include a data obtainer (1706), a measurement value determiner (1708), a color cell determiner (1710), a calendar matrix generator (1714), a calendar view determiner (1716), a time line generator (1718), a time line to calendar linker (1720), and a time line selector mechanism (1722). The data structures shown stored in the memory resources (1704) include a color library (1712).

The memory resources (1704) include a computer readable storage medium that contains computer readable program code to cause tasks to be executed by the processing resources (1702). The computer readable storage medium may be tangible and/or non-transitory storage medium. The computer readable storage medium may be any appropriate storage medium that is not a transmission storage medium. A non-exhaustive list of computer readable storage medium types includes non-volatile memory, volatile memory, random access memory, memristor based memory, write only memory, flash memory, electrically erasable program read only memory, magnetic storage media, other types of memory, or combinations thereof.

The data obtainer (1706) represents programmed instructions that, when executed, cause the processing resources (1702) to obtain data from sensors. The measurement value determiner (1708) represents programmed instructions that, when executed, cause the processing resources (1702) to determine the value of the measurements taken with the sensors based on the data obtained from the sensors.

The color cell determiner (1710) represents programmed instructions that, when executed, cause the processing resources (1702) to determine the color to display in the cells of the time based layouts based on the determined measurement values and to reference the color library (1712), which associates colors with measurement values. The calendar matrix generator (1714) represents programmed instructions that, when executed, cause the processing resources (1702) to generate a calendar matrix based on the colors of the cells. The calendar view determiner (1716) represents programmed instructions that, when executed, cause the processing resources (1702) to determine which calendar units of the calendar matrix to display in the display.

The time line generator (1718) represents programmed instructions that, when executed, cause the processing resources (1702) to generate an interactive data set time line based on the calendar matrix. The time line to calendar linker (1720) represents programmed instructions that, when executed, cause the processing resources (1702) to link the interactive data set time line to the calendar matrix. Such linking may be manifested to a user when a highlighted portion of the interactive time line corresponds with the time duration of the calendar view or a selected calendar unit of the calendar view. The time line selector mechanism (1722) represents programmed instructions that, when executed, cause the processing resources (1702) to provide a mechanism for the user to select a portion of the calendar matrix using the interactive data set time line.

Further, the memory resources (1704) may be part of an installation package. In response to installing the installation package, the programmed instructions of the memory resources (1704) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (1702) and the memory resources (1074) are located within the same physical component, such as a server, or a network component. The memory resources (1704) may be part of the physical component's main memory, caches, registers, non-volatile memory, or elsewhere in the physical component's memory hierarchy. Alternatively, the memory resources (1704) may be in communication with the processing resources (1702) over a network. Further, the data structures, such as the libraries and may be accessed from a remote location over a network connection while the programmed instructions are located locally. Thus, the display system (1700) may be implemented on a user device, on a server, on a collection of servers, or combinations thereof.

The display system (1700) of FIG. 17 may be part of a general purpose computer. However, in alternative examples, the display system (1700) is part of an application specific integrated circuit.

While the examples above have been described with reference to specific layouts; such as hour layouts, day layouts, week layouts, month layouts, and year layouts; any appropriate time based layouts may be used. For example, the layouts may represent any appropriate period of time such a multiple minute layout, a half hour layout, other time based layouts, or combinations thereof.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method of visual analytics of multivariate data using a cell based calendar matrix having a visual folding mechanism, comprising:
forming a time based layout that is divided into cells where the cells represent measurement intervals and a color of the cells represents a measurement value;
folding the time based layout into a cell based calendar matrix with other time based layouts that include other cells that represent corresponding measurement intervals in different calendar units of the cell based calendar matrix; and
displaying the cell based calendar matrix in a display such that the cells of the time based layout align by time with the other cells of the other time based layouts.

2. The method of claim 1, further comprising displaying an interactive data set time line that is synchronized with the cell based calendar matrix.

3. The method of claim 2, further comprising displaying the interactive data set time line with the cell based calendar matrix where the interactive data set time line highlights a time that represents a selected calendar unit.

4. The method of claim 2, further comprising selecting a calendar unit with through user interaction with the interactive data set time line displayed with the cell based calendar matrix.

5. The method of claim 1, wherein the cell based calendar matrix comprises different calendar units which include hour units, day units, week units, month units, year units, or combinations thereof.

6. The method of claim 1, further comprising switching between different calendar views in the display based on user input.

7. The method of claim 6, wherein the calendar views include an hour view, a day view, a week view, a month view, a year view, or combinations thereof.

8. The method of claim 1, wherein the time based layout is an hour layout.

9. The method of claim 1, wherein the hour layout is divided into three columns and four rows to form sequential measurement intervals.

10. A system of visual analytics of multivariate data using a cell based calendar matrix having a visual folding mechanism, comprising:
a layout engine to form a time based layout that is divided into cells where the cells represent measurement intervals and a color of the cells represents a measurement value;
a folding engine to fold the time based layout into a cell based calendar matrix with other time based layouts that include other cells that represent corresponding measurement intervals in different calendar units of the cell based calendar matrix;
a display engine to display the cell based calendar matrix in a display such that the cells of the time based layout align by time with the other cells of the other time based layouts; and
a time line engine to link a selected calendar unit to a corresponding time on an interactive data set time line displayed with the cell based calendar matrix in the display.

11. The system of claim 10, further comprising a switching engine to switch between different calendar views of the calendar matrix.

12. The system of claim 11, wherein the calendar views include an hour view, a day view, a week view, a month view, a year view, or combinations thereof.

13. The system of claim 10, wherein the cell based calendar matrix comprises different calendar units which include hour units, day units, week units, month units, year units, or combinations thereof.

14. The system of claim 10, further comprising a selecting engine to select a calendar unit of the different calendar units in the cell based calendar matrix based on user interaction with the interactive data set time line.

15. A computer program product of visual analytics of multivariate data using a cell based calendar matrix having a visual folding mechanism, comprising:
a non-transitory computer readable storage medium, the non-transitory computer readable storage medium comprising computer readable program code embodied therewith, the computer readable program code comprising program instructions that, when executed, causes a processor to:
form a time based layout that is divided into cells where the cells represent measurement intervals and a color of the cells represents a measurement value;
fold the time based layout into a cell based calendar matrix with other time based layouts that include other cells that represent corresponding measurement intervals in different calendar units of the calendar matrix;
display the cell based calendar matrix in a display such that the cells of the time based layout align by time with the other cells of the other time based layouts;
link a selected calendar unit to a corresponding time on an interactive data set time line displayed with the cell based calendar matrix in the display; and
select the calendar unit based on user interaction with the interactive data set time line.
